(19) United States
(12) Patent Application Publication
(10) Pub. No.: US 2006/0281443 A1
(43) Pub. Date: Dec. 14, 2006

(54) Method and system for facilitating voice mailbox operations for a mobile phone that is capable of operating in both a CDMA and GSM environment

(76) Inventors: Michael Chen, Pittstown, NJ (US); Robert Ephraim, Bridgewater, NJ (US); Tyler McCue, Lantana, TX (US); Michael P. Austin, Roanoke, TX (US)

Correspondence Address: DARBY & DARBY P.C., P. O. BOX 5257, NEW YORK, NY, 10150-5257, US

(21) Appl. No.: 11/132,727

(22) Filed: May 18, 2005

(51) Int. Cl. H04M 11/10

(52) U.S. Cl. 455/413

(57) ABSTRACT

A method and system is disclosed for facilitating voice mailbox operations for a mobile phone capable of operating in both a CDMA and a GSM environment. The system has at least first and second switching points and a global switching point in communication with a control point. Upon a first switching point detecting a busy/no answer condition for a request to terminate a call to a called station (the call originating from a calling station), the first switching point forwards the terminating call to a temporary, unique forward-to number belonging to the global switching point which then sends at least one message to the control point, the at least one message identifying the unique forward-to number designating a voice mailbox. The control point then identifies the second switching point from the unique forward-to number and sends a first call treatment message instructing the second switching point to apply voicemail treatment at a voice mailbox linked thereto.

### FIELD OF THE INVENTION

The present invention relates generally to telecommunication networks and, more particularly, to a method and system for directing a CDMA service subscriber's call to voice mail while roaming in a GSM service area.

### BACKGROUND OF THE INVENTION

In traditional call processing for cellular CDMA networks, incoming calls from a mobile handset or landline telephone are routed through the network to the home network of the called subscriber. Calls to the particular subscriber subject to call forwarding are typically rerouted by the subscriber's home mobile switching center (subscriber home MSC) to an alternate, forward-to telephone number (e.g., Voicemail).

Different types of call forwarding are commonly available. In a call forwarding—busy (CFB) feature, calls are forwarded to the forward-to number only if the called subscriber's handset is busy. In a call forwarding—no answer (CFNA) feature, calls are forwarded to the forward-to number only if the called subscriber's handset is not busy but nonetheless does not answer. With CFB and CFNA features, the Subscriber Home MSC forwards the call to the forward-to number typically only after an unsuccessful attempt to terminate the call to the called subscriber' handset.

CDMA MSCs utilize routing methods such as steering digits or Message Retrieval Service (MRS) indices for providing voice mail delivery. Common to all voice mail delivery methods, the home MSC receives the status of the current call (i.e., busy, no reply, no answer), polls the home location register (HLR) for call treatment and routes the call to the subscriber's voice mail box.

The above described prior art method of voice mail routing suffers from numerous deficiencies when a subscriber is roaming in a global system for mobile communications (GSM) environment making it undesirable from various standpoints. Since the GSM serving MSCs are not configured to send the call back to the subscriber's home CDMA MSC the home MSC cannot apply treatment as discussed above. Furthermore, if a GSM serving MSC was able to forward the call back to the home MSC further complications would follow. Namely, since there would be no way to associate the incoming call from the GSM MSC with the original call, it would appear to the home MSC as a new incoming call. As such, the home MSC could potentially forward it back to the GSM MSC creating a loop condition or, possibly, not treat the call at all.

One solution has been to use a dedicated, “global” voice mail platform for all global phone subscribers and call routing can be provided to the global platform through a dedicated voice mail access number or voice mail open trees number. This solution commonly relies on the charge number parameter, in the ISUP Initial Address Message (IAM), to provide proper voice mail box identification. However, using the charge number to provide proper voice mail box identification has several drawbacks making it an undesirable solution for providing voicemail access. For example, when a cellular subscriber is roaming internationally this charge number parameter is not available, requiring the caller to re-enter the mobile directory number (MDN) to deposit or retrieve voicemail messages, thus creating an unnecessary burden on the caller.

### SUMMARY OF THE INVENTION

The present invention provides significant improvements in voice mailbox operations for a CDMA service subscriber roaming in a GSM service area and overcomes the disadvantages described above by leveraging the current redirect request (RedReq) methodology utilized for roaming CDMA subscribers to enable the home MSC to route undeliverable calls (e.g., calls with a call status of busy, no answer or not reachable) to the subscribers voice mail platform.

A method and system is disclosed for facilitating voice mailbox operations for a mobile phone capable of operating in both a CDMA and a GSM environment. The system has at least first and second switching points and a global switching point in communication with a control point. In accordance with the present invention, upon a first switching point detecting a busy/no answer condition for a request to terminate a call to a called station (the call originating from a calling station), the first switching point forwards the terminating call to a temporary unique forward-to number belonging to the global switching point which then sends at least one message to said control point, the at least one message identifying the unique forward-to number designating a voice mailbox. The control point then identifies the second switching point from the unique forward-to number and sends a first call treatment message instructing the second switching point to apply voicemail treatment at a voice mailbox linked thereto.

The method and system removes all call routing to the global voicemail platform rendering this platform obsolete for all CDMA service subscribers roaming in a GSM service area since the subscriber's existing voicemail platform off of their home MSC will remain in use. Since cellular subscribers may each have a different home MSC, this arrangement also cuts down on routing costs when the subscriber is roaming domestically because undeliverable calls need not be routed to a single dedicated voicemail platform as discussed above but rather can be forwarded directly to the subscribers home voicemail platform. Additionally, by using a unique forward-to number to identify a voicemail box as opposed to the charge number the need for re-entry of the called party's MDN when the called party is roaming in a GSM environment is eliminated.

These and further aspects, features and advantages of the present invention will become more apparent from the following description when taken in connection with the accompanying drawings which show, for purposes of illustration only, several embodiments of the present invention.

### BRIEF DESCRIPTION OF THE DRAWINGS

FIG. 1 is a block diagram of a prior art telecommunication system;

FIG. 2 is a block diagram of a telecommunication system in accordance with an illustrative embodiment of the present invention;

FIG. 3 is a call flow diagram in accordance with the prior art telecommunication system of FIG. 1; and

FIGS. 4-5 are call flow diagrams in accordance with an illustrative embodiment of the present invention.

### DETAILED DESCRIPTION OF PREFERRED EMBODIMENTS

The present invention described herein includes a method and system for facilitating voice mailbox operations for a mobile phone that is capable of operating in both a CDMA and GSM environment.

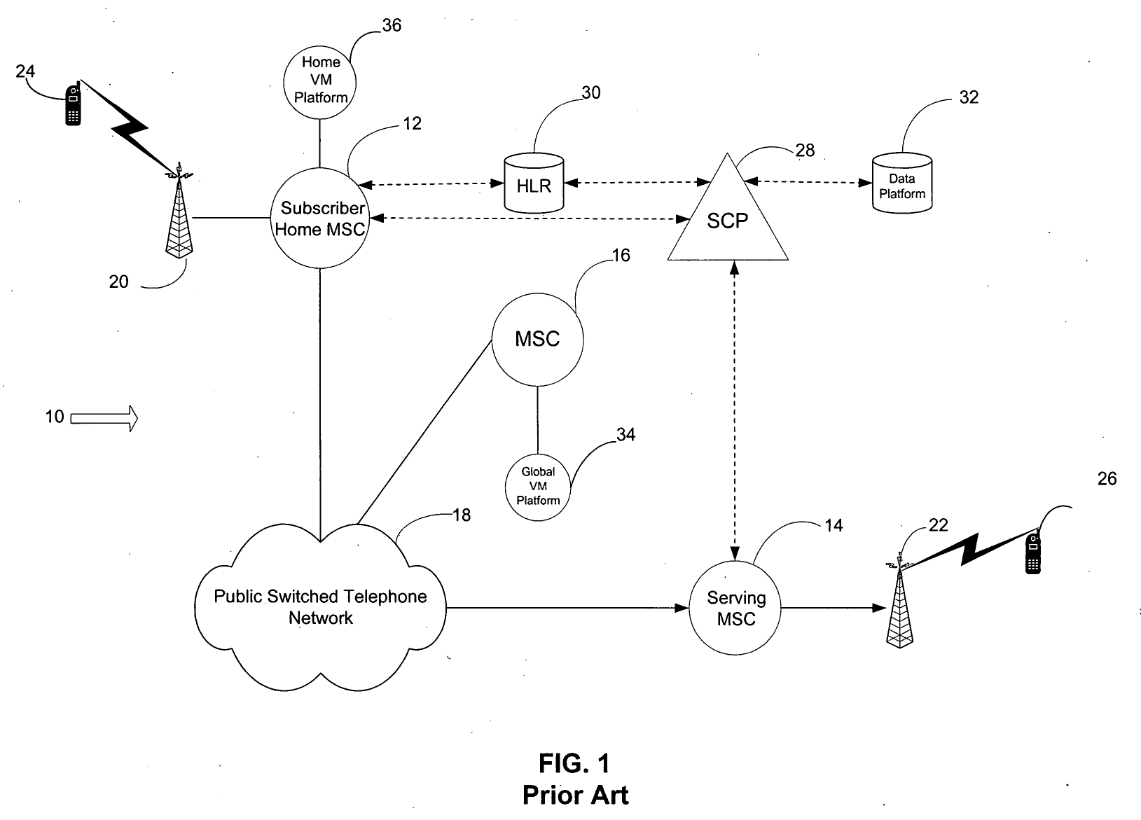

Referring to FIG. 1, a block diagram for a telecommunications system 10 is shown which depicts a prior art arrangement for facilitating voice mailbox operations for a CDMA service subscriber roaming in a GSM service area. Dashed lines indicate connections that carry primarily signaling traffic and solid lines indicate connections that carry primarily bearer traffic, such as voice, data, or other media.

Telecommunications system 10 includes mobile switching centers (MSCs) 12, 14 and 16 connected to a public switched telephone network (PSTN) 18. MSCs 12 and 14 are connected to base transceiver stations (BTSs), such as BTS 20 and 22, respectively. As understood by one skilled in the art, MSC 16 may also connect to one or more BTSs. BTSs 20 and 22 communicate over an air interface with one or more wireless devices, such as mobile handsets 24 and 26, to provide wireless telecommunications within a wireless coverage area. The communication between BTS 20, 22 and respective mobile handsets 24, 26 may occur in a digital format, such as CDMA, TDMA, GSM, or 802.11x, or it may occur in an analog format, such as AMPS. In some salient arrangements, MSC 12 may be connected to BTS 20 via a base station controller and/or other networks or systems.

Mobile handsets 24, 26 are each associated with a home MSC and have a mobile directory number (MDN) that corresponds to a directory number allocated to the mobile handset's home MSC. Such mobile handsets are typically able to operate in the wireless coverage areas served by their home MSCs, and they are also typically able to “roam,” i.e., to operate in wireless coverage areas served by MSCs other than their home MSCs. In the examples described herein, mobile handset 26 has MSC 12 as its home MSC and is roaming in a GSM serving area serviced by MSC 14 (serving MSC). Mobile handset 24 may, although not necessary to the spirit of the present invention, also have MSC 12 as its home MSC.

MSCs 12, 14 preferably use the advanced intelligent network (AIN) approach of having much of the signaling and call processing logic provisioned in a central service control point (SCP) 28, such as a Syniverse™ Uniroam platform, rather than in the switch itself. SCP 28 is a centralized signaling point providing signaling interoperability for international roaming. Specifically, SCP 28 is an ANSI-41 call processor that provides translation of international roaming protocols and interoperability among the various revisions of the TIA/EIA ANSI-41 signaling family. SCP 28 enables wireless operators to use one signaling point instead of directly routing to hundreds of switches and networks around the world and enables network elements in one country to route messages to other countries without the need for indirect routing in the home or serving network.

As described above, the AIN approach allows a wireless user to make and receive phone calls while roaming in areas outside the user's home network. Referring to FIG. 1, MSC 12 exchanges messages with SCP 28 in accordance with the specification TIA/EIA ANSI-41 signaling protocol which is incorporated herein by reference. Other signaling protocols could also be used. MSC 12 also exchanges messages with home location register (HLR) 30, which signaling may conform to IS-41 specifications. A recent revision of the IS-41 specifications, ANSI/TIA/EIA-41-D-97, published in December 1997, is incorporated herein by reference.

SCP 28 has access to data records stored in data platform 32. Data platform 32 stores the pooled temporary assigned local directory numbers (PTLDNs) and home MDN information and enables mapping necessary for call delivery, validation and billing. Data platform 32 can be external to SCP 28, or it may be wholly or partially internal to SCP 28 and may include volatile and/or non-volatile data storage.

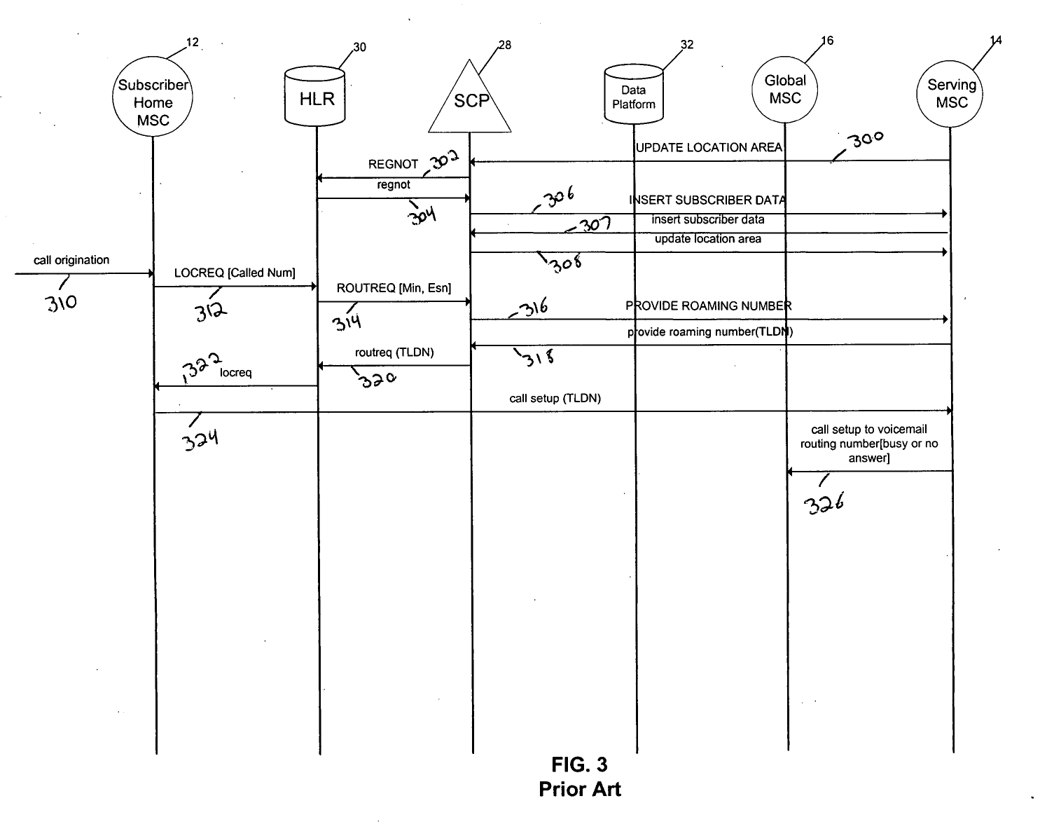

During call processing, when call delivery is attempted to a subscriber roaming in a GSM environment, MSCs 12 and 14 signal/communicate with SCP 28. Referring to FIG. 3, one example of messaging between switching points according the prior art arrangement of FIG. 1 is shown. The roaming subscriber handset 26 goes through a registration process at steps 308 whereby SCP 28 selects the dedicated voicemail routing number to act as a forward-to number in the event a call forwarding—busy (CFB) or call forwarding—no answer (CFNA) indicator is activated. An UPDATE LOCATION AREA containing the handset's IMSI is sent from serving MSC 14 to the SCP 28 (step 300). The UPDATE LOCATION AREA can be translated through a REGNOT. At step 302 the UPDATE LOCATION AREA is transferred to a REGNOT and the REGNOT is forwarded by SCP 28 to HLR 30. Upon reception of a REGNOT, HLR 30 sends a registration return result (regnot) to SCP 28 at step 304. SCP 28 has to translate the regnot into an update location return result to the serving switch 14. After the update location return result is forwarded to the serving switch 14 at step 306, SCP 28 will change the calling feature indicators for CFB and CFNA to authorized and activated with the dedicated voicemail routing number and INSERT SUBSCRIBER DATA and locreq messages.

At some time after registration a call comes into the subscriber's home MSC 12 (step 310) in response to which MSC 12 sends a location request (LOCREQ) to the subscriber's HLR 30 at step 312. HLR 30 then sends a route request (ROUTREQ) to SCP 28 at step 314. SCP 28 sends a PROVIDE ROAMING NUMBER to the serving switch 14 (step 316) and then the serving switch 14 sends a TLDN in a provide roaming number return result message to SCP 28 (step 318). The SCP 28 then sends a routreq response message at step 320, including the TLDN, to HLR 30 instructing MSC 12 on how to process the call. Signaling between MSC 12 and SCP 28 may also be routed through one or more signal transfer points (not shown).

MSC 12 then attempts to connect the call through serving MSC 14 (step 324). If a busy or no answer condition is encountered at the handset, the serving MSC 14 will forward the call to global MSC 16 (step 326) for treatment by global voicemail platform 34. Referring to FIG. 1, global voicemail platform 34 is a dedicated voicemail platform for all global phone subscribers. This can result in increased routing, requiring the serving MSC 14 to route the call between several intermediate MSCs.

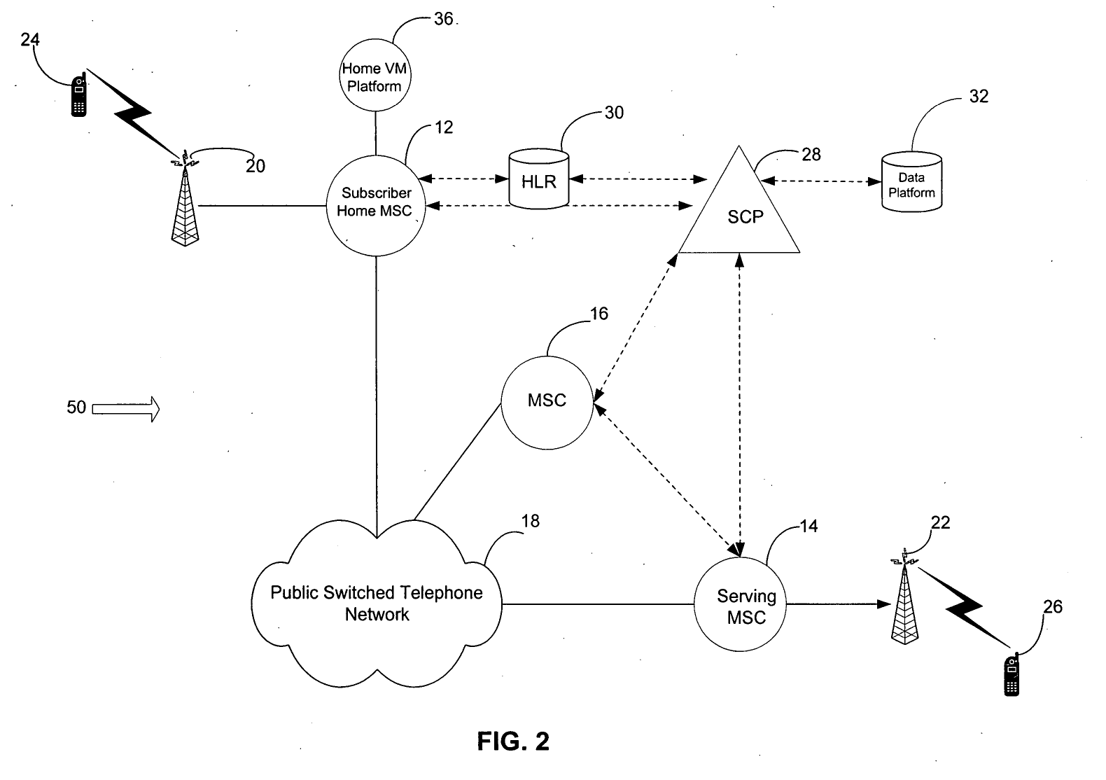

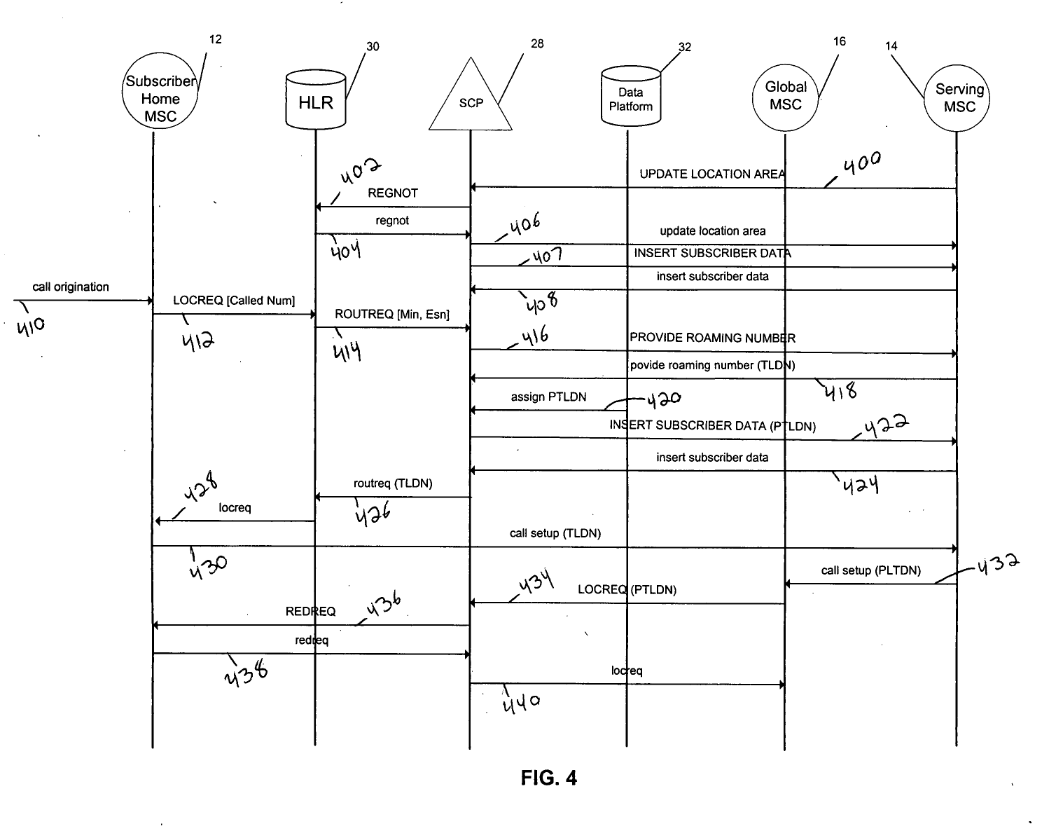

FIG. 2 is a block diagram for a telecommunications system 50 which depicts an improved exemplary arrangement for facilitating voice mailbox operations for a CDMA service subscriber roaming in a GSM service area in accordance with the present invention. FIG. 4 illustrates the flow of messaging traffic for system 50. Referring now to FIG. 2, unlike the prior art arrangement discussed above which included a dedicated voicemail platform 34 for all global phone subscribers, here, the serving MSC 14 can re-direct calls to home MSC 12 for voicemail treatment by the home voicemail platform 36, rendering global voicemail platform 34 of FIG. 1 obsolete. Additionally, whereas communication between MSC 16 and SCP 28 in the prior art arrangement was unnecessary to call-forwarding operations, here, such communication advantageously allows SCP 28 to populate the call forwarding treatment upon an incoming call. As described in greater detail below, upon encountering a busy/no answer condition at the serving MSC 14, the serving MSC 14 forwards the PTLDN via an IAM message to MSC 16 which will re-direct the call to home MSC 12 to initiate voicemail treatment.

When handset 26 roams in a GSM environment, upon encountering an incoming call for the subscriber 26, SCP 28 populates a PTLDN for use when CFNA or CFB indicators are activated/triggered. Referring to FIG. 2, any redirected calls are processed by the system as follows: a call is routed to serving MSC 14 for delivery to subscriber handset 26; if a busy/no answer condition occurs, serving MSC 14 sends an IAM containing a PTLDN to MSC 16; MSC 16 receives the IAM and sends a LOCREQ to SCP 28, SCP 28 maps the PTLDN in the LOCREQ, to a corresponding MIN/ESN/BID and it sends a REDREQ (with the MIN/ESN/BID) to the subscriber's home MSC 12; interaction between MSC 12 and HLR 30 in regards to a treatment for the REDREQ (containing busy or no answer status) results in steering digits or MRS index being sent back to the MSC 12; and the home MSC 12 routes the call to the subscriber's home voicemail platform 36.

Referring to FIG. 4, the flow of messaging traffic for the above outlined system is illustrated in greater detail. Several of the below steps have been discussed above with reference to FIG. 2 and are now repeated with respect to specific messaging between the various system components. Unlike the prior art solution shown in FIG. 3, where the Dedicated VM number is assigned upon registration, here, the PTLDN is assigned during an incoming call. Otherwise, registration proceeds as discussed above. During an incoming call after registration, SCP 28 selects a PTLDN to represent a call forwarding (forward-to) number in the event of a CFB or CFNA condition occurs and sets the PTLDN at the serving MSC 14 via an insert subscriber data message.

After registration, the system proceeds as follows: a call placed on handset 24 (step 410) comes into home MSC 12; a location request (LOCREQ) is sent from MSC 12 to HLR 30 (step 412); HLR 30 sends a ROUTREQ to SCP 28 to obtain a TLDN and to set call forwarding parameters (step 414); SCP 28 sends a PROVIDE ROAMING NUMBER to the serving switch 14 (step 416); MSC serving switch 14 sends a provide roaming number return result with a TLDN (step 418); the SCP 28 accesses data records stored in data platform 32 to secure a PTLDN (steps 420); the SCP 28 sends an INSERT SUBSCRIBER DATA message to assign the pooled TLDN for CFB/CFNA (step 422); a routreq return results with a TLDN used to deliver the call (step 426); HLR 30 sends a locreq to home MSC 12 (step 428) and the call is delivered to the serving MSC 14 via the TLDN at step 430; upon a busy/no answer condition at serving MSC 14, serving MSC 14 attempts to call forward by sending an IAM to the global MSC 16 by sending an IAM including the PTLDN to global MSC 16 (step 432) which in turn prompts MSC 16 to send a LOCREQ including the PTLDN to SCP 28 (step 434); at step 436 SCP 28 sends a REDREQ message to home MSC 12; MSC 12 sends a TRANNUMREQ request to HLR 30 (not shown); trannumreq is returned to MSC 12 with voicemail treatment (not shown); and home MSC 12 sends call to voicemail (not shown) and at the same time tears down the call leg to the TLDN established at step 430 (not shown). MSC 12 sends a redreq to the SCP 28 (step 438); and the SCP 28 sends a locreq to the Global MSC 16 (step 440).

Two of the above discussed steps need to occur at the SCP 28 to enable SCP 28 to instruct the home MSC to redirect the call: the unique forward-to number (the PTLDN) for each incoming call is defined at the SCP 28 (step 420) and a LOCREQ for the PTLDN call is received from MSC 16 by the SCP 28 (step 434). The SCP also retains the PC_SSN (point code subsystem number) received in the ROUTREQ so that if the call encounters a busy condition the SCP will have the information necessary to route a request to MSC 12 to be redirected. Without a unique PTLDN assigned for the incoming call and associated MIN/ESN/BID, SCP 28 will not be able to request the home MSC 12 to redirect the call because it will not know where to send the REDREQ. Since SCP 28 handles all global calls and is capable of assigning the forward-to number, when it receives a LOCREQ from MSC 16 at step 434 it will have the mapping information (the pre-specified PTLDN for a given MDN) required to send a REDREQ to the home MSC 12 that services the MIN/ESN/BID. Thus, the voicemail PTLDN contained in the LAM sent from serving MSC 14 through the LOCREQ at MSC 16 acts as a trigger telling SCP 28 to send a REDREQ to home MSC 12. For example, when SCP 28 receives the LOCREQ (containing a PTLDN) in step 434 it maps that PTLDN to the subscriber's MIN/ESN/BID and launches a REDREQ to the subscriber's home MSC 12. Since, the PTLDN range can be completely contained at one of the network switches such as MSC 16, or any other switch in the network, SCP 28 will not require voice trunking capabilities.

Unlike the prior-art telecommunications system 10 which routes CFB and CFNA events through PSTN 18 to a dedicated global voicemail platform 34, when a Busy/No Answer condition occurs in telecommunications system 50, the serving MSC 14 routes the call to SCP 28 via MSC 16 since the forward-to number (PTLDN) “belongs” to the SCP. This is accomplished by sending an IAM containing the PTLDN to MSC 16, which in turn sends a LOCREQ to SCP 28. Since SCP 28 is capable of mapping a subscriber's MIN/ESN/BID to the TLDN, when SCP 28 receives the IAM it is able to generate a REDREQ to the Subscriber's MIN/ESN/BID including a reason why access was denied (e.g., busy/no answer). When the Subscriber's home MSC 12 receives the REDREQ (with access reason denied), it can provide proper treatment (as it customarily would for domestically roaming subscribers) by routing the call to the subscriber's home voicemail system based on a trannureq from HLR 30.

Accordingly, since the call is not physically routed to home MSC 12, SCP 28 does not need voice trunking or switching capabilities. The call is “routed” back to the Home MSC via signaling messages, the IAM to the MSC 16, the LOCREQ to SCP 28, and the REDREQ to the home MSC 12. Such a process is facilitated by building the translations or triggers at MSC 16 and SCP 28 to send their corresponding messages when they receive a message from the previous party. The call from home MSC 12 to serving MSC 14 (step 420) is torn down and is not routed back to the home MSC 12 because it is already there. Thus, to the serving MSC 14 no call is charged because the call appears as no answer and disconnected from the originating home MSC 12. The SCP is preferably capable of sending a REDREQ to home MSC 12 for the above discussed benefits to be realized.

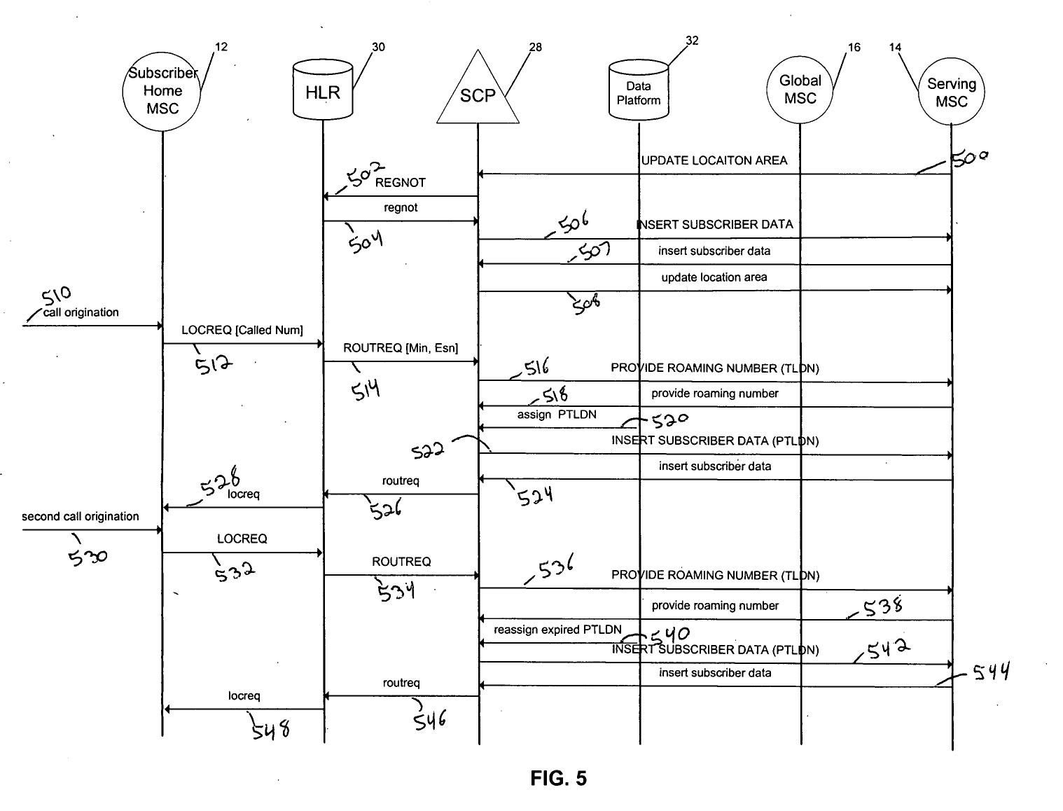

An example of an implementation of the above system is as follows. At some time after registration a call comes into the subscriber's home MSC 12 in response to which MSC 12 sends a LOCREQ to the subscriber's HLR 30 at step 412. HLR 30 then sends a ROUTREQ with a set of relevant parameters, i.e., with MIN/ESN/BID, to SCP 28 at step 414. SCP 28 sends a PROVIDE ROAMING NUMBER to the serving switch 14 (step 416). MSC serving switch 14 sends a provide roaming number return result with a TLDN accesses data records stored in data platform 32 to secure a PTLDN (steps 418). The SCP 28 sends an INSERT SUBSCRIBER DATA message to assign the pooled TLDN for CFB/CFNA (step 422). Next, SCP 28 requests data platform 32 to assign the PLTDN. Then data platform 32 checks the PTLDN table for a currently “in use” entry, most likely from a previous call, associated with the MIN/ESN specified in the ROUTREQ, and if no match is found, data platform looks in the table for a free or expired PTLDN. If a PTLDN is free, data platform 32 assigns it to the MIN/ESN for a configurable interval, or if a PTLDN is expired (no longer in use) data platform 32 deactivates it from the current MIN/ESN and reassigns it to the new MIN/ESN for a configurable interval. Reassignment of PTLDNs is discussed later in greater detail with reference to FIG. 5. Continuing with FIG. 4, the SCP 28 instructs the data platform 32 to assign a PTLDN. Referring to step 420, data platform 32 sends a PTLDN back to SCP 28 and SCP 28 sets the calling feature indicators for CFB and CFNA to authorized. With CFB and CFNA set, SCP 28 sends a INSERT SUBSCRIBER DATA to MSC 14 to and SCP 28 responds to each invoke request of data platform 32 with the assigned PTLDN. Finally, at step 426, SCP 28 sends the routreq with the TLDN (different than the PTLDN) to HLR 30 of the subscriber's home MSC 12.

With call forwarding setup, when MSC 12 receives the TLDN (different than PTLDN) at step 428 it attempts to the complete the call to the serving MSC 14 through the PSTN and waits for either answer supervision or for an incoming IS41 message such as a REDREQ. Thus, the home MSC 12 is still in the process of call delivery. If a busy or no answer condition is encountered the serving MSC 14 call forwards the call and sends an IAM to global MSC 16 at step 432. MSC 16 is a conventional mobile switching center and any MSC, including the subscriber's home MSC 12, can act in place of MSC 16. MSC 16 then sends a location request (LOCREQ message) with the PTLDN to SCP 28. As discussed above the LOCREQ received by SCP 28 for the transfer attempt acts as a trigger for SCP 28 to send a REDREQ to home MSC 12 (CDMA environment). Specifically, SCP 28 uses the PTLDN in the invoke to look-up the MIN/ESN that was assigned the PTLDN and sends a REDREQ message to the subscriber's home MSC 12 including the identified MIN/ESN and a redirection reason parameter set to busy. When MSC 12 receives the REDREQ it will essentially treat is as exactly as it would if the request came from a domestically roaming subscriber roaming in a CDMA environment because that is normally how calls are handled by a MSC when it receives a REDREQ while the call delivery attempt is still in progress. SCP 28 knows to send the REDREQ to MSC 12 when it receives the LOCREQ from the serving MSC 14 to transfer the call. Thus, as long as SCP 28 has a means to know when to send the REDREQ to the home MSC 12 while the call delivery attempt (from the home MSC's 12 perspective) is still in progress, the call will transfer using the home MSC 12 translations and subscriber profile. From the home MSC's 12 perspective, this will essentially look transparent and no different than if handset 26 was roaming locally in a CDMA environment. Additionally, the billing ID in the REDREQ will be the billing ID from the last ROUTREQ successfully processed by SCP 28. This is applicable for a two or more incoming calls scenario and for CFB treatment for the last call received.

While FIG. 2 shows only MSCs 12, 14 and 16 in communication with SCP 28, in general SCP 28 may communicate with a plurality of network MSCs. SCP 28 essentially appears as another roaming MSC' to the other MSCs. Also, PSTN 18 may be connected to other switching points that do not signal to SCP 28, i.e., MSC 16 discussed with respect to the prior art arrangement of FIG. 1. Instead, such switching points may exchange messages with a different control point, or they may not use the intelligent network approach for call processing at all.

FIG. 5 illustrates the steps for reassigning expired PTLDNs. Discussion of steps 500-508 has been eliminated as these steps proceed essentially the same as steps 400-408 discussed above. Turning to step 512, a LOCREQ containing a called number is sent from home MSC 12 to HLR 30. Next, at step 514, a ROUTREQ with a new MIN/ESN is sent from HLR 30 to SCP 28. In this instance SCP 28 checks the data platform 32 and finds that all PTLDNs are in use but that one or more entries have expired. The expired PTLDN can then be assigned to the new MIN/ESN and call processing continues as in FIG. 4 discussed above.

One skilled in the art will appreciate that the present invention is not limited to use with CDMA and GSM systems. Rather, it is understood that the present invention is applicable to any combination of wireless telecommunications systems where a Redirection Request or corresponding functionality is not sent from a serving MSC to a home MSC to instruct the home MSC to redirect the call. Thus, for example, the above described method and system is applicable to a situation involving any ANSI 41 standard switch and any ITU based switch.

We claim:

1. A method for facilitating voice mailbox operations for a mobile phone capable of operating in both a CDMA and a GSM environment having at least first and second switching points and a global switching point in communication with a control point, said method comprising:
a first switching point detecting a busy or no answer condition for a request to terminate a call to a called station, said call originating from a calling station;
said first switching point forwarding said call to a temporary unique forward-to number belonging to said global switching point;
said global switching point receiving said forward-to number and sending at least one message to said control point, said at least one message identifying the unique forward-to number designating a voice mailbox;
said control point identifying the second switching point from said unique forward-to number; and
said control point sending a first call treatment message instructing the second switching point to apply voicemail treatment at a voice mailbox linked thereto.

2. The method of claim 1, wherein said first call treatment message comprises the call status indicator.

3. The method of claim 1, wherein said call status indicator identifies a busy, no answer or not reachable condition at the called station.

4. The method of claim 1, wherein said control point identifying step further comprises:
said control point mapping the forward-to number to the calling station's mobile directory number.

5. The method of claim 1, further comprising an initial registration step prior to said first switching point detecting step, said registration step comprising the control point assigning said forward-to number to the calling number's mobile directory number.

6. The method of claim 1, wherein said control point identifying step occurs prior to said control point sending step.

7. The method of claim 1, wherein said first and second switching points are mobile switching centers (MSCs) and said called station is roaming in a GSM wireless coverage area served by the first switching point.

8. The method of claim 1, wherein said control point is a service control point (SCP).

9. The method of claim 1, wherein said second switching point represents the calling station's home MSC.

10. The method of claim 1, wherein said unique forward to number is a pooled temporary local directory number (PTLDN) and said at least one message is a LocReq invoke for the PTLDN.

11. The method of claim 1, wherein said first call treatment message is a RedReq message containing the call status indicator.

12. The method of claim 1, further comprising the step of tearing down the call by said second switching point after receiving the first call treatment message.

13. A method of network controlled call forwarding between a call arriving at a first switching point for delivery to a second switching point, wherein both first and second switching points are configured to communicate with a control point, comprising the steps of:
setting call forwarding parameters by securing a unique forward-to number from the control point after a call enters the network and prior to delivering the call;
delivering the call to the second switching point;
receiving a busy/no answer condition at the second point;
sending an IAM containing the forward-to number to the control point; and
said control point mapping the forward-to number to the first control point and forwarding thereto to initiate voicemail treatment.

14. The method of claim 13 wherein the unique forward-to number is a PTLDN.

15. The method of claim 13 wherein said securing step comprises the control point accessing data records stored in a data platform accessible thereto.
